(19) United States
(12) Patent Application Publication
(10) Pub. No.: US 2024/0110302 A1
(43) Pub. Date: Apr. 4, 2024

(54) IN-SITU QUATERNARIZATION AND CROSS-LINKING OF ANION EXCHANGE MEMBRANES DERIVED THEREFROM

(71) Applicant: PAUL KOHL, Atlanta, GA (US)

(72) Inventor: PAUL KOHL, Atlanta, GA (US)

(21) Appl. No.: 18/369,632

(22) Filed: Sep. 18, 2023

Related U.S. Application Data
(60) Provisional application No. 63/407,922, filed on Sep. 19, 2022.

(51) Int. Cl. C25B 13/08; B01J 41/14; C08J 5/22

(52) U.S. Cl. CPC C25B 13/08; B01J 41/14; C08J 5/2243; C08J 2345/00

(57) ABSTRACT

In a method of forming an anion conducting polymer membrane, a prepolymer membrane solvent-casting solution is generated. At least one non-cross-linking tertiary amine is added to the prepolymer membrane solvent-casting solution. The membrane is cast from the at least one non-cross-linking tertiary amine and the prepolymer membrane solvent-casting solution after the adding step. In another method of forming an anion conducting polymer membrane, a prepolymer membrane solvent-casting solution is generated. At least one non-cross-linking tertiary amine is added to the prepolymer membrane solvent-casting solution. The membrane is cast from the at least one non-cross-linking tertiary amine and the prepolymer membrane solvent-casting solution after the adding step.

### CROSS-REFERENCE TO RELATED APPLICATION(S)

This application claims the benefit of U.S. Provisional Patent Application Ser. No. 63/407,922, filed Sep. 19, 2022, the entirety of which is hereby incorporated herein by reference.

### BACKGROUND OF THE INVENTION

### 1. Field of the Invention

The present invention relates to a series of polycycloolefinic polymers, which function as ion conducting polymers suitable as anion exchange membranes and/or electrode-forming ionomers for fabricating a variety of electrochemical devices. More specifically, the polymers used herein are derived from a variety of functionalized norbornene monomers which can be converted into ion conducting polymers. This invention also relates to using an anion conducting solid polymer electrolyte as the ion conducting medium between the two electrodes. The ion conducting medium acts as the ionic conduit between the electrodes where electroactive material at the electrodes can be oxidized or reduced. The electrochemical devices made in accordance with this invention are useful as fuel cells, redox flow batteries, hydrogen-producing water electrolysis devices, chemical separations, and the like.

### 2. Description of the Related Art

Energy conversion devices using solid polymer electrolytes such as fuel cells, electrolyzers to produce hydrogen from water, redox flow batteries and chemical separations are promising options because of their device simplicity, high thermodynamic efficiency, and solid-state design. These devices are also scalable and can be used for transportation, remote and distributed power, small- and large-scale facilities for electricity and hydrogen production, and for separating specific chemicals, such as carbon dioxide, oxygen, or hydrogen. Fuel cells are a clean energy conversion technology with the potential to reduce the use of fossil fuels. Fuel cells can be used in stationary power generation, portable electronics, and transportation. In addition, fuel cells are environmentally friendly, can be easily refueled, and can have high energy conversion efficiency. Electrolyzers producing hydrogen from water are an emerging enabling technology for the hydrogen economy. Electrochemical separations can enrich or deplete gas or liquid feed streams of chemical species, such as carbon dioxide, oxygen, and hydrogen.

Various solid polymer electrolytes in the form of membranes are used in electrochemical devices. There are at least two broad categories of polymer electrolyte membranes, namely, proton (or cation) exchange membranes (PEMs), and hydroxide (or anion) exchange membranes (AEMs). An advantageous attribute of AEMs or PEMs is its fabrication simplicity for forming electrodes on the membrane. The solid polymer electrolyte can support a pressure difference between the two electrodes so that the user does not have to balance the pressure on the two sides of the membrane (like in liquid electrolyte devices). Although there are commercial fuel cell electric vehicles and stationary fuel cell power generators based on PEM membranes, they are still economically challenged because they employ platinum-based electrocatalysts and the PEM membranes use perfluorinated polymers which are expensive and hazardous to make.

On the other hand, AEM-based devices have the potential to lower the cost-of-ownership of these electrochemical devices compared to PEM-based devices because the high pH anionic environment has facile oxygen reduction reaction (ORR) and oxygen evolution reaction (OER) kinetics, enabling the use of non-platinum catalysts. In addition, a variety of low-cost monomers can be used to synthesize hydrocarbon-based hydroxide ion conducting polymers that are stable in alkaline conditions, compared to the expensive perfluorinated polymers needed for PEM membranes.

However, early AEM membranes suffered from low ion conductivity, poor chemical stability at high pH, and high water-uptake causing unacceptable swelling. Recent results show that some AEMs have (i) high anion (e.g. hydroxide) conductivity (e.g. >100 mS/cm at 80° C.), (ii) long-term alkaline stability at elevated temperature and pH (e.g., 80° C. in 1 M NaOH), (iii) robust mechanical properties for withstanding in-use pressure differences and avoiding polymer creep under compression, and (iv) control over excessive water uptake by cross-linking.

Anion conductive membranes can be synthesized as a prepolymer where an alkyl halide group is pendent on the polymer backbone. The synthesis of the prepolymer includes the chemical reaction of one or more monomers to form a polymer. The monomer arrangement within the polymer can be either random or in ordered blocks (i.e., block copolymer). One or more of the monomers within the polymer is chosen to have a pendent alkyl halide functional group. The alkyl halide is later converted to a cation tethered to the polymer backbone by reaction with a tertiary amine forming a quaternary ammonium cation with mobile halide anion. The halide anion can be later exchanged for hydroxide. The conversion of the pendent alkyl halide to the anion-conducting quaternary ammonium (by reaction with a tertiary amine) is performed after polymer synthesis and membrane fabrication because the ionic quaternary amine salt is not very soluble in the non-polar synthesis solvent. Monomers containing a quaternary ammonium halide pendent group do not polymerize into a polymer due to problems with the solvent and catalyst.

A polymer film can be fabricated from the prepolymer after polymer synthesis by solvent casting. An effective way to form high-volume, thin-film membranes from the prepolymer after polymer synthesis is by roll-to-roll (R2R) processing. In R2R processing, the prepolymer is dissolved into a solvent and the resulting solution is continuously spread across a belt and dried. The resulting film is rolled into a cylinder for future unrolling and use. In this way, large quantities of polymer film can be manufactured in an economical and automated way. The rolled-up membrane can be used later in other R2R processes to make large quantities of membrane electrode assemblies for fuel cells, electrolyzers or other devices. An inert organic or inorganic reinforcement layer can be used during membrane casting to improve the mechanical properties of the resulting membrane.

After the prepolymer has been formed into a membrane by R2R solvent casting, the alkyl halide monomer in the prepolymer can be converted into an anion-conducting moiety by chemical reaction with a tertiary amine or phosphine. For example, a bromobutyl norbornene monomer in a poly(norbornene) polymer can be converted into trimethyl quaternary ammonium bromide by reaction with trimethyl amine. Although the finished anion conducting polymer has desirable properties, conversion of the alkyl halide prepolymer film to the quaternary ammonium anion conducting polymer is problematic. The conversion of the alkyl halide prepolymer to a quaternary ammonium cation is often called quaternarization. In the quaternarization reaction, the solvent-cast membrane is soaked in the liquid tertiary amine so that the amine can diffuse into the prepolymer to form the quaternary ammonium halide moiety. The diffusion of the tertiary amine into the polymer film can be a slow process taking hours or even days. The quaternarization step cannot effectively be performed when the membrane has been rolled into a cylinder because the tertiary amine solution cannot easily penetrate the thick polymer roll. The quaternization step cannot be performed during R2R film fabrication because the diffusion of the tertiary amine into the prepolymer film takes a long time compared to the time the membrane is in the R2R fabrication facility. For example, a 30 um thick poly(norbornene) film containing butyl bromide norbornene monomers was first made by solvent casting the poly(norbornene) from toluene solvent in a R2R process line. The 30 um film was unrolled and cut into small sheets and soaked in 40% aqueous trimethyl amine for 24 hours to fully convert it to the ion conductive quaternary ammonium bromide salt. The 24 hour soak in aqueous trimethyl amine was carried out in a vented fume hood due to the extreme odor and danger of trimethyl amine. Thus, soaking large quantities of polymer film in an amine is disruptive to the otherwise smooth-flowing R2R process and dangerous due the large quantity of tertiary amine needed for long soaking time.

It is important to cast the membrane when the material is in the prepolymer form because once the membrane is quaternarized into the quaternary ammonium halide, the anion conductive polymer is a salt and is no longer sufficiently soluble in the toluene organic solvent. Further, it is often desirable to partially crosslink the prepolymer during solvent casting to control its mechanical properties and water uptake of the final film. Once crosslinked, the solubility of the polymer in a solvent is further reduced. The net effect is that quaternarization takes place after the membrane has been solvent cast in a non-R2R soaking process requiring long soak times in toxic amine.

Thus, one is faced with having to perform quaternarization in a slow batch process involving cutting the roll of membrane into smaller sheets so that they can be exposed on all sides with tertiary amine for an extended time. Once cut into small sheets, the membrane film can no longer be used in subsequent R2R processes because it is no longer a roll. Substitution of a larger tertiary amine, such as dimethyl ethyl amine, diethyl methyl amine, triethyl amine, piperidinium or the like, would only compound the problem by making diffusion of the amine into the membrane slower. There is also concern that the ultimate anion conductivity is less than optimum because the polymer microstructure of the solvent-cast polymer does not leave space for the incoming tertiary amine. Once the tertiary amine has reacted with the alkyl halide, the volume of the quaternary ammonium halide is greater than that of the original alkyl halide.

Accordingly, there is a need for a method of performing the quaternarization process in a R2R-compatible process and avoid the problematic, batch quaternarization process. There is also a need for a method of casting the polymer membrane after quaternization so that the microarchitecture of the polymer is optimum for the quaternary ammonium halide salt with the polymer.

### SUMMARY OF THE INVENTION

Applicant has found that the addition of a non-cross-linking tertiary amine directly to the prepolymer/solvent mixture used in casting a membrane does not immediately quaternarize the prepolymer (rendering the product insoluble in the solvent solution). It is further recognized that addition of a multi-functional tertiary amine cross-linker does not interfere with the tertiary amine quaternarization, and the amine does not interfere with the multi-functional amine crosslinker. Thus, the tertiary amine (resulting in quaternarization of the prepolymer) and multi-functional tertiary amine (cross-linker) can be directly added to the prepolymer/solvent mixture before solvent casting the membrane. When the solvent is allowed to evaporate after casting the membrane, the chemical reactions of quaternarization and cross-linking can be completed simultaneously resulting in a cross-linked, anion conductive membrane without the need for expensive and dangerous soaking of the cast membrane in a tertiary amine solution. It has been further observed that the amount of tertiary amine used in quaternarization need not be excessive, as it is with post-casting amination. Near stoichiometric amounts of tertiary amine was used in the membrane. This limits the tertiary amine chemical emission, which are dangerous and expensive. It has been further discovered that the ionic conductivity of the in-situ aminated and cross-linked membrane is superior to the conductivity of a comparable membrane made via an existing technique.

The disadvantages of the prior art are overcome by the present invention which, in one aspect, is a method of forming an anion conducting polymer membrane, in which a prepolymer membrane solvent-casting solution is generated. At least one Menshutkin reactant is added to the prepolymer membrane solvent-casting solution. The Menshutkin reactant does not result in cross linking. The membrane is cast from the Menshutkin reactant and the prepolymer membrane solvent-casting solution after the adding step.

In another aspect, the invention is a method of forming an anion conducting polymer membrane, in which a prepolymer membrane solvent-casting solution is generated. At least one non-cross-linking tertiary amine is added to the prepolymer membrane solvent-casting solution. The membrane is cast from the at least one non-cross-linking tertiary amine and the prepolymer membrane solvent-casting solution after the adding step.

In yet another aspect, the invention is n ion conducting membrane that has a hydroxide conductivity of at least 72 mS/cm at 20° C.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a graphic chemical representation of a Menshutkin reaction.

FIG. 2 is a graph showing percent amination with TMA in THE as a function of reaction time at 40° C. and room temperature.

FIG. 3 is a graph showing pre-cast IEC (using NMR), post-cast IEC (using titration), and conductivity of films prepared using in-situ TMA amination process at room temperature (left) and 40° C. (right).

FIG. 4 is a graph showing percent amination with piperidinium in THE as a function of reaction time at 40° C. and room temperature.

FIG. 5 is a graph showing electrolyzer voltage vs time using pre-cast aminated membrane and post-cast aminated membrane.

FIG. 6 is a graphic chemical representation of an ion conducting poly(norbornene) polymer in an ion conducting membrane.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy”, “thioalkyl”, “alkoxyalkyl”, “hydroxyalkyl”, “alkylcarbonyl”, “alkoxycarbonylalkyl”, “alkoxycarbonyl”, “diphenylalkyl”, “phenylalkyl”, “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy”, “cycloalkylalkyl”, “cycloalkylaryl”, “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy”, is to be construed accordingly. It should further be noted that certain of the alkyl groups as described herein, such as for example, “alkyl” may partially be fluorinated, that is, only portions of the hydrogen atoms in said alkyl group are replaced with fluorine atoms and shall be construed accordingly.

As used herein the expression “acyl” shall have the same meaning as “alkanoyl”, which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight or branched hydrocarbon chain having the specified number of carbon atoms and containing at least one carbon-carbon double bond, and includes ethenyl and straight-chained or branched propenyl, butenyl, pentenyl and hexenyl groups. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include benzofuranyl, benzothiophenyl, indolyl, quinolinyl, isoquinolinyl, cinnolyl, benzimidazolyl, indazolyl, pyridofuranyl, pyridothienyl, and the like radicals.

As used herein, the term “quaternization” and “amination” refer to the chemical transformation of a halogenated alkyl functional group to a quaternary amine, such as by the Menshutkin chemical reaction of the halogenated alkyl group with a tertiary amine. One example is the reaction of the bromobutyl substituent on poly(norborene) with trimethyl amine to yield trimethyl ammonium bromide. The bromide ion can be subsequently ion exchanged for other anions, include hydroxide.

As used herein, the term “prepolymer” refers to the non-ion conducting form of the polymer before it has been converted into the ion conducting form, such as by reaction with a tertiary amine (i.e., amination reaction) or by reaction with a phosphine molecule.

In one representative embodiment, an ion conducting poly(norbornene) (PNB) copolymer was synthesized using vinyl addition polymerization of bromobutyl norbornene (BrNB) and butyl norbornene (BuNB). Equimolar quantities of (η3-allyl)Pd(iPr3P)Cl and Li[FABA] were dissolved in toluene and trifluorotoluene in a drybox. The solution was stirred for 30 minutes, allowing the formation of cationic Pd sites which can initiate the polymerization. A 5% monomer solution was separately prepared by adding BuNB and BrNB (25:75 molar ratio) to toluene and stirred until a homogeneous solution was formed. The monomer solution was added dropwise to the initiator under constant stirring over the next hour. The solution was then stirred in an inert atmosphere glovebox for 24 hours. After polymerization was completed, the solution was quenched in methanol and the precipitated polymer was filtered. The polymer was purified by dissolving in THF and stirring over activated charcoal for 30 minutes. Subsequently, the solution was passed through an alumina filter and precipitated in methanol. The purification step was repeated several times to ensure there were no residual impurities. The polymer was vacuum dried in an oven (0.5 atm) at 70° C. for 24 hours. Subsequently, the polymer was milled with dry ice in a grinder to form a fine powder. The molar ratio of BuNB:BrNB in the PNB was found by integrating proton peaks 0.89 ppm and 3.42 ppm divided by three and two, respectively, in the proton NMR. In-situ NMR experiments were carried out by dissolving the PNB in d-TIF, adding the reactants, and transferring the solution to an NMR tube. The conversion was monitored as a function of time. The conventional method for casting membranes involved stirring the PNB in toluene for 60 minutes allowing it to dissolve completely. The polymer was crosslinked by adding N, N, N′, N′-tetramethyl-1,6-hexanediamine (TMHDA) at a specific molar ratio with respect to the total moles of halogenated monomers, BrNB. 5% crosslinking (i.e. 5 mol % with respect to the BrNB groups) was used unless otherwise stated. The crosslinked copolymer solution was then filtered through a 0.45 um poly(tetrafluoroethylene) (PTFE) membrane syringe. The polymer solution was carefully drop-cast in an aluminium pan, and it was allowed to dry in an overpressure of solvent followed by oven drying at 60° C. for 6 hours.

The dried PNB membranes made by existing methods were aminated ex-situ by soaking in aqueous trimethyl amine for different time intervals. The time required for complete functionalization varied depending on the aminating agent, crosslinking density, membrane thickness, and reaction temperature. Generally, membrane is soaked in 45% aqueous trimethylamine (TMA) at room temperature for 24 to 72 hours for complete amination. The aminated membranes were soaked in 1M NaOH for 1 hour to allow bromide ions to be exchanged for hydroxide.

The in-situ aminated and cross-linked membranes, in accordance with this invention, were made by dissolving the polymer in a suitable solvent, similar to the conventional process. The temperature of the solution was controlled at room temperature or at elevated temperatures (e.g., 40° C. under constant stirring). Stoichiometric excess quantities of the tertiary amine (e.g., 50 mol % excess with respect to the available BrNB groups) were added to the polymer solution at a specific temperature. The solution was stirred for a specific time and N, N, N′, N′-tetramethyl-1,6-hexanediamine (TMHDA) was added before casting. The polymer solution was drop-cast into an aluminum pan, and the solution was allowed to dry for 24 hours in solvent overpressure to prevent cracking due to thermal stresses. Subsequently, the membranes were dried in an oven at 60° C. overnight. The functionalized membranes were soaked in 1M NaOH for 2 hours to ion exchange.

The membrane conductivity was measured using a four-point probe jig. The membrane was cut into a 3×1 cm rectangle and immersed in pure water during the test. A small current was applied to the outer two probes and the voltage drop across the inner two probes was measured.

The ion exchange capacity of the membranes was measured after casting by titration. The functionalized membrane was immersed in a 1M potassium chloride solution for 48 hours to exchange the bromide ions for chloride. The membrane was dried in a vacuum oven overnight and weighed. The dry membrane in chloride form was washed with water and soaked in 1M NaNO₃ solution for 48 hours, allowing the chloride ions to exchange with the nitrate in the solution. The sodium nitrate solution (now containing chloride ions) was titrated with 0.013M silver nitrate solution using potassium chromate as the indicator. The end point in the titration was the formation of yellow/brown silver chromate.

The water uptake (WU) of the membrane was measured using dry piece of membrane in hydroxide form. The sample was weighed before and after soaking in deionized water for 48 hours. Post soaking, the membrane was removed from water, and dabbed to remove the surface water.

The ionomers used to make the device electrodes were synthesized from three different norbornene monomers: butyl norbornene (BuNB), bromobutyl norbornene (BrNB), and norbornene-2-propionic acid tert-butyl ester (NBPTBE). The initiator solution is prepared by dissolving equimolar quantities of (η3-allyl)Pd(iPr3P)Cl and Li[FABA] in a mixture containing equal quantities of toluene and trifluorotoluene. Separately, the three monomers were dissolved in toluene in 50:30:20 and 20:60:20 mole ratio to form a 5% solution. The monomer solution was added dropwise to the initiator under constant stirring and the contents were allowed to stir for 24 hours in an inert atmosphere. The polymerization was quenched by precipitation in methanol and purified. After synthesis, the ionomers were milled with dry ice to form a fine powder. The powdered ionomers were added to HCl (37% w/w) and the heterogenous mixture was refluxed for 48-72 hours to convert the ester norbornene monomer to a carboxylic acid norbornene. The ionomer was then vacuum filtered, rinsed with methanol, and vacuum dried in an oven at 70° C. for 24 hours.

The electrodes were prepared by using a solvent cast technique. 50 mg of the ionomer was stirred into 8 ml THE until dissolved. 8 mg of bis(phenol)-A-digycidyl ether epoxy (180 g eq epoxy equivalent weight) was added to the solution. 100 mg of Pt₃Ni was added to the ionomer solution and the resulting mixture was sonicated in an ice bath for 1 hour. The slurry was sprayed onto carbon paper porous transport layer (PTL) and allowed to dry in a vacuum oven at 160° C. The anode was prepared in the same way by using the 50:30:20 ionomer but the catalyst was changed to nickel ferrite and the resulting slurry was sprayed onto stainless steel PTL. The electrodes were soaked in aqueous trimethyl amine to convert the halogenated portion of the polymer to ion-conducting quaternary ammonium groups. The electrodes were then washed with DI water and soaked in 1.5M NaOH solution for 60 minutes to exchange the bromide ions for hydroxide.

The electrolyzer experiments used the anion exchange membrane in hydroxide form between the electrodes described above and squeezed between 5 cm² hardware. The flow-fields were made of 316 stainless steel and had a serpentine single pass flow field. Anode and cathode electrodes used 50:30:20 and 20:60:20 ionomers, respectively. The hydrogen evolution reaction (HER) cathode was operated dry and electrolysis was performed at 60° C. The current density was fixed to 1 A cm⁻². The AEM electrolyzer was conditioned at 0.1 A cm⁻² until a steady voltage was achieved. The current density was increased slowly in 0.25 A cm⁻² steps until 1 A cm⁻² was achieved. High-frequency resistance (HFR) of the cell was obtained at 0.1 V.

The molecular weight of the PNB was characterized using size exclusion chromatography. The number average molecular weight (Mn) of the synthesized polymer was 54.7 kDa and the dispersity was 1.78. Higher and lower PNB molecular weights can be used in this invention.

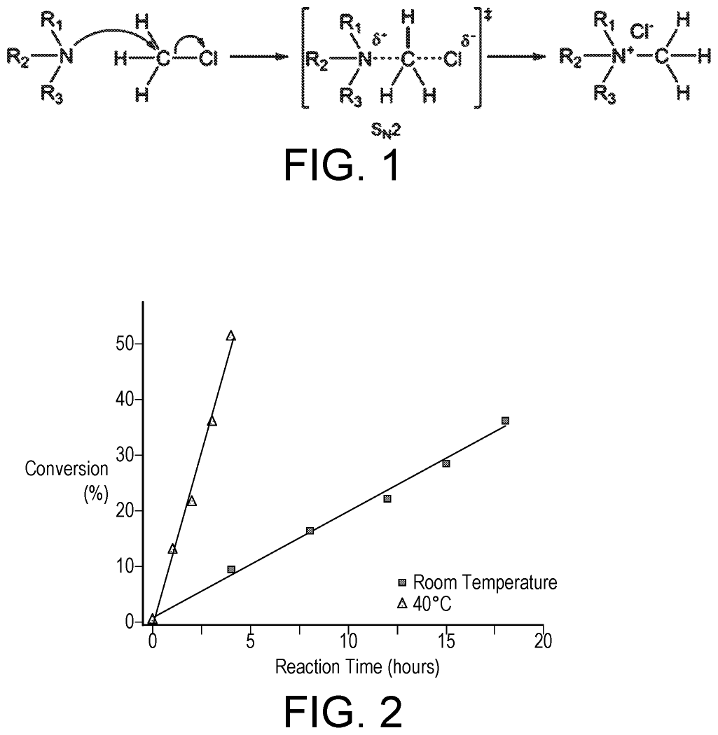

The PNB synthesized polymer containing BrNB or other halogenated alkyl groups can be quaternized by reaction of the halogenated alkyl group with a suitable aminating compound, such as a non cross-linking tertiary amine. This amination reaction converts the halogenated alkyl into a quaternary tethered cation and mobile anion, which makes the membrane anion conductive. Quaternary ammonium and piperidinium head-groups have shown good conductivity and chemical stability. These functional groups can be formed through the Menshutkin reaction, as shown in FIG. 1. It is desirable to have a smaller size ion conducting head-group because that will lead to a higher ion exchange capacity (IEC). Three tertiary amines trimethyl amine, triethyl amine, and N-methyl piperidine, were used to from ion conducting PNB.

The rate of reaction for the Menshutkin reaction depends on the nature of the solvent used. It is desirable to select a solvent for the PNB that leads to a high Menshutkin reaction rate and also has high solubility for PNB when it is in the prepolymer (i.e., pre-aminated) form (non-ion conducting) and in the aminated form (ion conducting). It is also preferable to have moderate to high vapor-pressure solvents for rapid film drying. A series of solvents were tested for PNB solubility, Table 1.

TABLE 1
Solubility of PNB in solvents:

| Solvent | Solubility | Dielectric Constant |
|---|---|---|
| Hexane | Insoluble | |
| Toluene | Soluble | 2.38 |
| Diethyl ether | Insoluble | |
| 1,4 Dioxane | Insoluble | |
| Tetrahydrofuran | Soluble | 7.58 |
| Dichloromethane | Insoluble | |
| Anisol | Insoluble | |
| Cyclopentanone | Insoluble | |
| Benzaldehyde | Insoluble | |
| Chloroform | Soluble | 4.81 |
| N-methyl pyrrolidine | Insoluble | |
| Trichlorobenzene | Insoluble | |
| Cyclopentyl methyl ether | Soluble | 4.76 |
| Dimethyl sulfoxide | Insoluble | |
| Dimethyl formamide | Insoluble | |
| Acetonitrile | Insoluble | |
| Propylene Carbonate | Insoluble | |
| Methanol | Insoluble | |
| Water | Insoluble | |

Table 2 shows that toluene, THF, cyclopentyl methyl ether, and chloroform have acceptable solubility for PNB. However, it is known that chloroform forms side products in the Menshutkin reaction which make it undesirable. Toluene, THF, and CPME were selected for further investigation. Preferably, the solvent will be selected so that the prepolymer casting solution will have a dielectric constant of at least 2.4.

The Menshutkin reaction is a type II SN2 reaction, as shown in FIG. 1. In the Menshutkin reaction, a tertiary amine is converted into a quaternary ammonium compound by reaction with an alkyl halide. Several factors affect the rate of the Menshutkin reaction such as nucleophile concentration, steric effects, the structure of the alkyl portion of the reactant, and choice of solvent. The reaction proceeds by formation of a dipolar transition state which then forms the ionic quaternary ammonium functional group. Applicant has found that use of a Menshutkin reactant does not result in cross-linking prior to casting the membrane.

While not being bound by theory, we propose that the solvent polarity is critical to this invention because it affects the polar transition state produced in the Menshutkin reaction. The transition state can be stabilized by a polar solvent. Thus, the overall reaction activation energy and rate can change depending on the solvent polarity. Polar solvents are more suitable for the Menshutkin reaction because a high polarity solvent promotes better charge stabilization for the transition state. This is expected to increase the reaction rate. However, excessive solvent polarity may lead to side products or a slow rate of product formation, both of which are undesirable. Protic solvents generally decrease the reaction rate of the Menshutkin reaction because they may contain acidic protons which can react with nucleophiles leading to deactivation. Polar aprotic solvents are preferred because they do not form hydrogen bonds and form a small solvent shell around the nucleophile which makes the nucleophile more accessible during reaction. Table 1 shows the dielectric constant for the four solvents with high PNB solubility. It is noted that toluene has the lowest dielectric constant of the four.

The solvents were investigated by dissolving PNB in toluene, CPME, and THF, and adding 45% aqueous TMA. The solution was heated to promote the TMA amination reaction with the bromoalkyl norbornene. An aliquot of each sample was analyzed after four hour reaction time. The highest reaction rate occurred in THF.

It is also important that the solvent dissolves the quaternized polymer product so that the solution can be used to solvent cast a membrane. If the quaternized polymer is not suitably soluble in the solvent and precipitates out of solution, high quality membranes cannot be easily formed. Table 2 shows the solubility of the aminated PNB as a function of percent amination (i.e., conversion). The amination conversion percent was assessed quantitatively using ¹³C NMR.

TABLE 3
Solubility of partially quaternized PNB in different solvents:

| Reaction time | | Conversion | Toluene | CHCl₃ | THF | CPME |
|---|---|---|---|---|---|---|
| 1 | hour | 12.83% | ● | ● | ● | ● |
| 2 | hours | 21.55% | ▴ | ● | ● | ● |
| 3 | hours | 33.91% | ◯ | ● | ▴ | ▴ |
| 4 | hours | 51.32% | ◯ | ▴ | ◯ | ◯ |

● - Soluble
▴ - Partially soluble
◯ - Insoluble

The results in Table 2 show that a longer reaction time leads to a higher conversion to of the bromoalkyl to the quaternary ammonium hea-group. Table 2 also shows that the solubility of the polymer decreases with percent conversion because the quaternized polymer is not as soluble and the pre-aminated polymer. The results from Table 1 and Table 2 taken together show that THE is the preferred solvent for amination and casting because the amination reaction rate was also sufficiently fast due to its moderate polarity and aprotic nature. Critical to the success of THF is its relatively high dielectric constant. This is favorable for the Menshutkin reaction.

The effect of temperature on the solubility of the quaternized polymer was studied by preparing a saturated solutions of the partially aminated PNB in THF at 21.55% conversion. Half of the saturated polymer solution was cooled, while the other half was heated to 50° C. The viscosity of each was compared. On cooling, there was an increase in solution viscosity and the polymer precipitated from solution. The solution viscosity was lower and the solubility was higher at 50° C. than room temperature. Thus, the combination of high dielectric constant (favorable Menshutkin reaction kinetics), warm temperature (for solubility), and lack of side reactions are key learning from these tests.

The effect of temperature on the rate of the amination reaction was further analyzed. FIG. 2 shows the percent amination at room temperature and 40° C. as a function of time. FIG. 2 shows that temperature accelerates the amination reaction rate. It was also observed that the polymer precipitated out of solution at a lower percent conversion at room temperature compared to 40° C., supporting the learning that warm conditions are superior to room temperature. Together these results show that both solubility and rate of amination increase with temperature, both of which are desirable for the in-situ amination before film casting. It was also observed that at 50° C. and 60° C., the rate of amination was too rapid and the polymer precipitated within 30 minutes. While higher temperature (e.g., 50° C. and 60° C.) could be made to work, the poor pot-life may make the film casting process difficult to control. Additional tests were performed on films made from amination at 40° C.

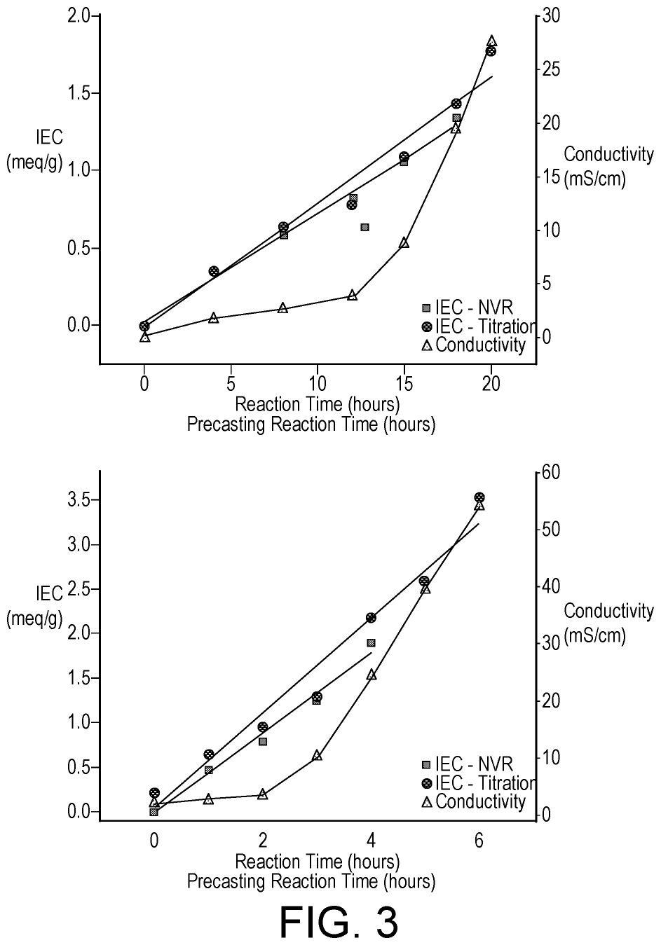

Membranes were cast using the claimed in-situ amination process. The temperature of the solution during the amination process, prior to membrane casting was varied. FIG. 3 shows the IEC and conductivity vs mixing time in THE prior to film casting at room temperature (left side graph) and at 40° C. (right side graph). As seen in FIG. 3, the IEC increased linearly with time as the amination reaction proceeded. The IEC was measured by NMR before the membrane was cast. The IEC was measured by titration after the membrane was cast because the film was no longer soluble after film formation. The IEC increased linearly in both cases, but the rate was more rapidly at 40° C. than room temperature. Full amination took approximately 20 hours of mixing at room temperature and about 6 hours of mixing at 40° C. It is noted that the mixing time before casting is not disruptive to roll-to-roll processing because once the solution has been mixed off-line, it can be cast into a fully aminated membrane

The ionic conductivity of the membrane increased with amination because the quaternary ammonium ions provide ionic conductivity. The rate of increase in conductivity with time is non-linear because ionic conductivity requires a contiguous ionic path through the polymer film. Until the concentration of ion head-groups in the polymer achieve a sufficiently high overall concentration, efficient ionic pathways are not formed. FIG. 3 shows that after 20 hours of mixing at room temperature, the IEC was only 1.8 meq/g and conductivity was only 27 mS/cm, at which point the polymer because insoluble in THF. Thus, 20 hours was the longest mixing time that could be used at room temperature, due to solubility, but it was not sufficient for conductivity. However, when mixed at 40° C., the IEC reached 3.5 meq/g and the conductivity was 54 mS/cm. This improvement at 40° C. compared to room temperature was due to the improved solubility of the aminated polymer in THF. Not only was the IEC and conductivity higher, but the solution was ready for film formation after only 6 hours of mixing, compared to 40 hours at room temperature. It is also noted that aminating the PNB before film casting makes a slightly more conductive film compared to the existing method of aminating a film by soaking in TMA after film formation, all other factors being equal. This is most likely because when the previously aminated film dries, the polymer chains can form a low-stress structure with optimal spacing. When amination occurs after film casting by diffusion of TMA into the film, the bromine on the alkly tail is converted into a quaternary ammonium cation and bromide anion. The size of the quaternary ammonium cation and bromide anion are larger than the starting bromoalkly tether volume. Thus, the polymer is forced into a non-optimal, compressed spacing which lowers the ion mobility.

The properties of PNB films prepared by the existing method (soaking in TMA after film formation) and the new method disclosed here (amination in solution prior to film formation) were investigated. A single polymer/TiF solution was prepared and TMHDA cross-linker was added so that the moles of TMHDA corresponded to 5% of the moles of bromoalkyl groups in the solution. The solution was divided into two. One half of the solution was directly cast into a membrane by pouring a thin layer in an aluminum dish followed by solvent evaporation and drying. The dried film was soaked in excess TMA for 48 hours to aminate the bromoalkyl groups (i.e., the existing method). The other half of the solution was heated to 40° C. and TMA was added. A 50% excess of TMA with respect to the number of moles of bromoalkyl groups on the polymer was used to ensure that adequate TMA was present. The solution was stirred for six hours at 40° C., according to FIG. 2. After the films were dry, both films were soaked in 1 M NaOH to exchange the bromide for hydroxide. The ionic conductivity, water uptake and IEC were measured, as described above and the results are shown in Table 3. In addition, the films were soaked in solvent to extract the unreacted TMHDA. The amount of unreacted TMHDA was quantified by weighing the samples before and after extraction.

Table 3 shows that the not only did the ‘pre-casting amination’ match the ionic conductivity of the ‘post-casting amination’ membrane, but it was 10% higher. This effect was described above where the quaternary ammonium head-groups fit within the dried polymer film better when the amination occurs before film casting. This leads to lower internal stress and higher ion conductivity because the size of the bromoalkyl group is smaller than the resulting trimethyl ammonium bromide head-group. This is also reflected in the higher apparent IEC. The water uptake and extractable mass loss are higher in the ‘pre-casting amination’ membrane. This is likely because the TMHDA-induced percent cross-linking is lower when the TMA and TMHDA compete with each other for bromoalkyl sites on the polymer. In the ‘post-casting amination’ film, the TMHDA was present in the polymer film prior to TMA addition and had a longer time to react. It should be noted that the degree of cross-linking in the ‘pre-casting amination’ film can be adjusted in several ways including adding more TMHDA (so its concentration and chance of reaction with bromoalkyl groups is higher) or letting the TMHDA react in the ‘per-casting amination’ film longer before adding TMA (so that the TMHDA pre-reacts before TMA has a change to compete).

TABLE 3
Comparison of film properties made from post-casting amination
(existing method) and pre-casting amination (current method):

| | Post-Casting Amination | | Pre-Casting Amination | |
|---|---|---|---|---|
| Property | (Existing Method) | | (Current Method) | |
| Conductivity | 66 | mS/cm | 72 | mS/cm |
| Water Uptake | 37% | | 55% | |
| IEC (titration) | 3.4 | meq/g | 3.8 | meq/g |

| | | |
|---|---|---|
| Extractable Mass Loss | 2.3% | 3.1% |

The effect of water on the rate of amination was investigated. It is known that polar solvents increase the rate of reaction. The 45 wt % aqueous TMA reactant was diluted to 20 wt % with water and the experiment in FIG. 3 was repeated. It was found that the reaction rate approximately doubled; however, the additional water changed the polymer solubility. Only 40% amination conversion could be achieved resulting in lower ionic conductivity films. This again shows the importance of maintaining high polymer solubility prior to film casting. TMA is often the preferred aminating compound when quaternization is carried out after film casting because TMA can diffuse into the solid membrane and convert the bromoalkyl group into a quaternary ammonium. Although larger tertiary amines and other reactants may be able to convert the bromoalkyl group into a cationic head-group, their diffusion into a solid film is very slow, or may not occur at all. There are other tertiary amines and phosphines that can be used to react with the bromoalkyl group on the polymer to yield an ion-conducting head-group, including dimethyl ethyl amine, diethyl methyl amine, triethyl amine, quinuclidine, N-methyl piperidine and the like. No such post film casting diffusion limitation is present for the present invention because the aminating reactant (e.g., TMA or other) is intimately mixed with the polymer when the polymer is accessible in solvent form (e.g., TIF). In one embodiment, the resulting ion conducting membrane has a hydroxide conductivity of at least 72 mS/cm at 20° C.

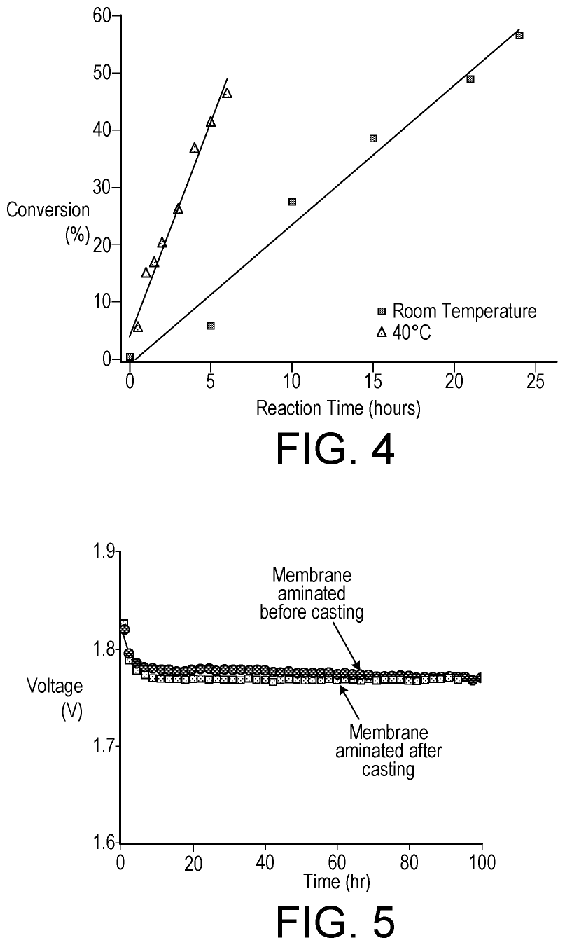

FIG. 4 shows the percent amination of PNB vs time when piperidinium was used in place of TMA at two different temperatures. The reaction rate is similar to TMA in FIG. 2. This shows that this new, pre-cast amination process permits the use of many different reactants to form the ion conducting head-group on the polymer because diffusion into the solid polymer film is not required. In addition, casting a film using a pre-aminated polymer results in a more relaxed, higher ion mobility film, as shown above. Also, phosphine reactants can be used in place of amine reactants to form anion conductive membranes.

The above described embodiments show that excellent membrane properties can be achieved by practicing this pre-casting amination process. The performance of the new membranes of the present invention were compared to existing membranes by using them in a membrane electrolyzer. FIG. 5 shows the electrolysis voltage vs time for a pre-cast aminated membrane and existing membrane vs time using the same batch of PNB. The electrolysis was performed at 1 A/cm² and 60° C. for 100 hours. The applied voltage of both cells was 1.77 V after 100 hours operation. This shows that the performance of the two membranes was essentially identical.

Anion conductive membranes can be used in many applications, including fuel cells, hydrogen producing electrolyzers, aqueous batteries, and electrodialysis. Anion conducting membranes can be made by solvent casting a non-ion conducting polymer (i.e., prepolymer) into a solid film followed by conversion to the ion conducing form using the Menshutkin reaction. The Menshutkin reaction converts a tertiary amine into a quaternary ammonium salt by reaction with an alkyl halide. Similar reactions occur when tertiary phosphines are treated with alkyl halides. The reaction is the method of choice for the preparation quaternary ammonium moieties within the polymer film. However, the post-casting amination reaction is slow and requires diffusion of a tertiary amine or phosphine into the solid polymer film. The aminated polymer is not sufficiently soluble in the casting solvent to cast the membrane after amination. It has now been found that the addition of a tertiary amine directly to the prepolymer/solvent mixture used in casting a membrane does not immediately quaternarize the prepolymer (rendering the product insoluble in the solvent solution). Thus, the tertiary amine (resulting in quaternarization of the prepolymer) and multi-functional tertiary amine (cross-linker) can be directly added to the prepolymer/solvent mixture before solvent casting the membrane.

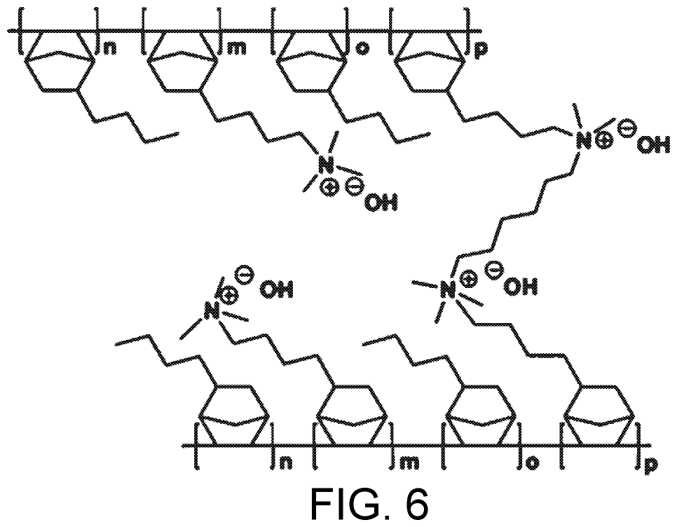

The ion conducting poly(norbornene) polymer in the ion conducting membrane is shown in FIG. 6. The polymer backbone can be in block copolymer form where the integers n, m, o and p are discrete numbers, or in a random form where the integers n, m, o and p can vary throughout the polymer. The trimethyl quaternary ammonium cation shown on the “m” monomer and the cross-linking moiety, shown on the “p” monomer, are both formed as a result of the Menshutkin reaction.

The membrane can be cast in roll-to-roll process, in which the membrane is quaternarized before casting, and stored in a cylindrical roll. Thus, the invention lends itself to industrial-scale membrane casting.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of forming an anion conducting polymer membrane, comprising the step of:
(a) generating a prepolymer membrane solvent-casting solution;
(b) adding at least one Menshutkin reactant to the prepolymer membrane solvent-casting solution, wherein the Menshutkin reactant does not result in cross linking; and
(c) after the adding step, casting the membrane from the Menshutkin reactant and the prepolymer membrane solvent-casting solution.

2. The method of claim 1, wherein the pre-casting solution is reacted at a temperature in a range of 20° C. to 80° C. prior to the step of casting the membrane.

3. The method of claim 1, wherein the prepolymer solvent-casting solution includes a solvent selected from a list consisting of: toluene, tetrahydrofuran, chloroform, cyclopentyl methyl ether, and combinations thereof.

4. The method of claim 1, wherein the prepolymer solvent-casting solution has a dielectric constant that is at least 2.38.

5. The method of claim 1, wherein the prepolymer solvent-casting solution has a dielectric constant that is at least 4.76.

6. The method of claim 1, wherein the casting step comprises a roll-to-roll process.

7. The method of claim 1, wherein the anion conducting polymer membrane comprises an ion conducting poly(norbornene) polymer.

8. The method of claim 1, wherein the ion conducting membrane has a hydroxide conductivity of at least 72 mS/cm at 20° C.

9. A method of forming an anion conducting polymer membrane, comprising the step of:
(a) generating a prepolymer membrane solvent-casting solution;
(b) adding at least one non-cross-linking tertiary amine to the prepolymer membrane solvent-casting solution; and
(c) after the adding step, casting a membrane from the at least one non-cross-linking tertiary amine reactant and the prepolymer membrane solvent-casting solution.

10. The method of claim 9, wherein the pre-casting solution is reacted at a temperature in a range of 20° C. to 80° C. prior to the step of casting the membrane.

11. The method of claim 9, wherein the prepolymer solvent-casting solution includes a solvent selected from a list consisting of: toluene, tetrahydrofuran, chloroform, cyclopentyl methyl ether, and combinations thereof.

12. The method of claim 9, wherein the casting step comprises a roll-to-roll process.

13. The method of claim 9, wherein the prepolymer solvent-casting solution has a dielectric constant that is at least than 2.38.

14. The method of claim 9, wherein the prepolymer solvent-casting solution has a dielectric constant that is at least 4.76.

15. The method of claim 9, wherein the anion conducting polymer membrane comprises an ion conducting poly(norbornene) polymer.

16. The method of claim 9, wherein the ion conducting membrane has a hydroxide conductivity of at least 72 mS/cm at 20° C.

17. An ion conducting membrane, comprising a membrane of formula (I) 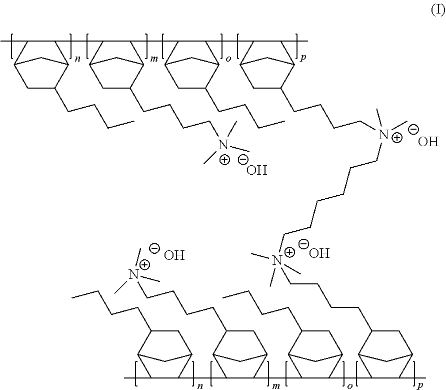
where n, m, o and p are discrete numbers and where m is a trimethyl quaternary ammonium cation and p is a cross-linking moiety,
wherein the ion conducting membrane has a hydroxide conductivity of at least 72 mS/cm at 20° C.

18. The ion conducting membrane of claim 17, configured to conduct anions.

19. The ion conducting membrane of claim 17, configured in a cylindrical roll.

20. The ion conducting membrane of claim 17, comprising an ion conducting poly(norbornene) polymer.
